(19) United States
(12) Patent Application Publication
(10) Pub. No.: US 2014/0084734 A1
(43) Pub. Date: Mar. 27, 2014

(54) Rotating Electrical Machine, Method for Manufacturing Magnetic Pole Piece

(71) Applicant: Hitachi Automotive Systems, Ltd., Hitachinaka-shi (JP)

(72) Inventors: Takashi ISHIGAMI, Yokohama (JP); Hiroshi KANAZAWA, Hitachiota (JP); Hidefumi IWAKI, Hitachinaka (JP)

(73) Assignee: Hitachi Automotive Systems, Ltd., Hitachinaka-shi (JP)

(21) Appl. No.: 13/955,615

(22) Filed: Jul. 31, 2013

(30) Foreign Application Priority Data
Sep. 26, 2012 (JP) 2012-212140

(51) Int. Cl. H02K 21/12; H02K 15/03

(52) U.S. Cl. CPC H02K 21/12; H02K 15/03
USPC 310/156.48; 29/598

(57) ABSTRACT

The present invention, in a rotating electrical machine having a configuration in which a plurality of magnetic pole pieces is attached along outer perimeters of the rotating axis, provides a structure of rotating electrical machine with small cogging torque by providing a skew in magnetic pole pieces. The rotating electrical machine according to the present invention comprises a plurality of magnetic pole pieces disposed with a skew angle and a cylindrical attachment ring for attaching the magnetic pole pieces, wherein an engaging portion provided at outer perimeters of the attachment ring and an engaging portion included in the magnetic pole pieces are both extended along the rotating axis.

### CLAIM OF PRIORITY

The present application claims priority from Japanese patent application JP 2012-212140 filed on Sep. 26, 2012, the content of which is hereby incorporated by reference into this application.

### BACKGROUND OF THE INVENTION

1. Field of the Invention

The present invention relates to a rotating electrical machine of motors, electrical generators, or the like.

2. Background Art

In association with global warming, increasing efficiency of rotating electrical machines of motors or electrical generators and promoting motorized cars using rotating electrical machines with small size and large torque are expected as effective measures for suppressing the global warming. Motor is referred to as heart of industry, and about 70% of electric power consumption in factories is caused by motors. Therefore, a power-saving effect corresponding to power generation by an electric generation plant of several hundreds thousand kW class could be expected by improving efficiency of motors by a few percent only.

On the other hand, electrifying each part of cars and expanding use of environment-responsive cars such as HEV (Hybrid Electric Vehicle) or EV (Electric Vehicle) are measures for suppressing the global warming in the transportation department. For example, a HEV may halve fuel cost compared to conventional gasoline cars to significantly decrease CO₂ emission. In addition, as an example of car electrification, changing the power steering system from conventional hydraulically-actuated system into motor-driven system may improve the fuel cost by 3 to 5% due to idling-stop effect, thereby also reducing CO₂ emission.

Rare-earth magnets such as neodymium magnets or samarium cobalt magnets that are used in rotating electrical machines have residual magnetic flux density three times as large as that of conventionally used ferrite magnets, and may exhibit strong attractive force. Thus in recent years, permanent magnet rotors using these rare-earth magnets are employed mainly in automotive motors in which small size and large torque are required or in compressor motors of air conditioners in which high energy efficiency is required, resulting in significant successful effects.

However, materials of these rare-earth magnets are referred to as rare-metals, the amount of deposit of these materials is extremely smaller than that of base metals such as iron or aluminum, and these rare-metals can be mined from limited places. Therefore, rare-earth magnets are much more expensive than conventional ferrite magnets. Under the above-described circumstances, while rare-earth magnets are advantageous components for achieving high efficiency, small size, and large torque of rotating electrical machines, a tendency for achieving equivalent motor performances without rare-earth magnets to provide low-cost rotating electrical machines have been activated.

According to above-mentioned backgrounds, using ferrite magnets with small magnetic coercive force and low unit cost per weight, rotating electrical machines using I-type interior permanent magnet rotors are proposed as measures for generating attractive force equivalent to that of neodymium magnets. However, I-type interior permanent magnet rotor has small effective magnetic flux density due to its magnets embedded in rotors and has large cogging torque (torque pulsation when the rotating electrical machine rotates at low speed with no electrical power provided) compared to conventional surface permanent magnet rotors. Therefore, it is assumed that I-type interior permanent magnet rotors are not suitable for rotating electrical machines that require high specs regarding cogging torques, such as for EPS (Electric Power Steering) motors.

JP Patent Publication (Kokai) No. 2009-50099 A discloses a technique, with an objective of “providing a rotor core, a permanent magnet rotor, and a permanent magnet synchronous rotating electrical machine in which performance degradation of rotating electrical machine due to decrease in magnetic flux density by skews is suppressed and that can be easily manufactured”, as “A rotor 1 is configured in which a permanent magnet 2 is inserted inside a permanent magnet insertion groove 34 formed obliquely to an axial direction of a rotor core 3 and in which neighboring magnets 2 are located with same poles facing to each other. A stator is disposed so that it faces to the rotor 1 through a gap. The rotor 1 and the stator are supported so that they can rotate relatively. These configurations provide a high performance permanent magnet motor without cogging torques.” (Abstract).

### SUMMARY OF THE INVENTION

In the technique described in JP Patent Publication (Kokai) No. 2009-2009-50099 A, the rotor core 3 is formed by stacked members with the groove 34 in which the permanent magnet 2 is inserted. Under the configuration, whole of the rotor core 3 is formed with the same material.

On the other hand, when attempting to form a part of the rotor (e.g. an inner perimeter portion adjacent to the rotating axis) using different materials, the configuration described in JP Patent Publication (Kokai) No. 2009-50099 A cannot be employed. Thus it is an objective of the present invention, in a rotating electrical machine having a configuration in which a plurality of magnetic pole pieces is attached along the outer perimeter of the rotating axis, to provide a structure of rotating electrical machine with small cogging torque by providing a skew in magnetic pole pieces.

The rotating electrical machine according to the present invention comprises a plurality of magnetic pole pieces disposed with a skew angle and a cylindrical attachment ring for attaching the magnetic pole pieces, wherein an engaging portion provided at the outer perimeter of the attachment ring and an engaging portion included in the magnetic pole pieces are both extended along the rotating axis.

The rotating electrical machine according to the present invention can suppress, by providing a skew angle in the magnetic pole piece, cogging torques under a rotor structure in which a plurality of the magnetic pole pieces is attached. In addition, since the portion where the attachment ring and the magnetic pole piece are engaged with each other is extended along the rotating axis, these components can be fitted stiffly to obtain a stiff rotor structure.

Technical problems, configurations, and advantageous effects other than mentioned above will be apparent according to the descriptions of embodiments below.

### BRIEF DESCRIPTION OF THE DRAWINGS

FIG. 1 is a diagram showing a rotor portion of an I-type interior permanent magnet rotor.

FIG. 2 is a diagram showing a rotor portion of a conventional surface permanent magnet rotor.

FIG. 3 is diagram showing a magnetic flux flow of an I-type interior permanent magnet rotor.

FIG. 4 is a diagram showing measures for fixing members in an existing I-type interior permanent magnet rotor.

FIG. 5 is s perspective view of an attachment ring 7.

FIG. 6 is a perspective view of a plate piece 9 for manufacturing the attachment ring 7.

FIG. 7 is a perspective view of a magnetic pole piece 3.

FIG. 8 is a perspective view of a permanent magnet 1.

FIG. 9 is a perspective view showing that the magnetic pole piece 3 and the permanent magnet 1 are disposed annularly.

FIG. 10 is a diagram showing a process to fit the attachment ring 7 into the magnetic pole piece 3.

FIG. 11 is a diagram showing another method for assembling the magnetic pole piece 3, the permanent magnet 1, and the attachment ring 7.

FIG. 12 is a perspective view of an assembly 13.

FIG. 13 is an internal perspective view of a rotating electrical machine equipping an I-type interior permanent magnet rotor 2 according to the embodiment 1.

FIG. 14 is a perspective view of a punched member 21 forming the magnetic pole piece 3.

FIG. 15 is a top view of two types of punches used for punching the punched member 21.

FIG. 16 is a diagram explaining a difference about positions where a steel plate is punched.

FIG. 17 is s perspective view showing that a plurality of the assembly 13 is stacked.

FIG. 18 is a diagram showing a configuration example in which coils are disposed instead of the permanent magnet 1.

### DETAILED DESCRIPTION OF THE PREFERRED EMBODIMENTS

### <Conventional I-Type Interior Permanent Magnet Rotor>

Hereinafter, a conventional I-type interior permanent magnet rotor will be described as a comparative example, and then a configuration of a rotating electrical machine according to the present invention will be described.

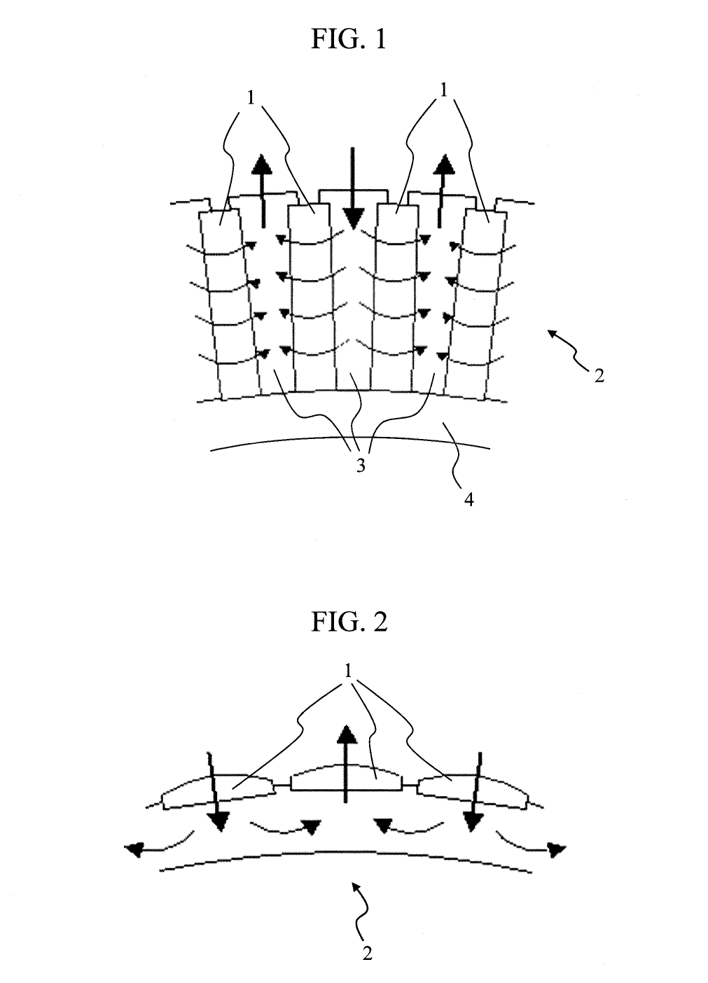

FIG. 1 is a diagram showing a rotor portion of an I-type interior permanent magnet rotor. I-type interior permanent magnet rotors are used as measures for generating attractive force equivalent to that of neodymium magnets using ferrite magnets having small magnetic coercive force and low unit cost per weight.

In I-type interior permanent magnet rotors, a segment magnet 1 is disposed so that a longitudinal direction of the segment magnet 1 is directed to a radial direction of a rotor 2. Namely, the inner perimeter surface of the stator is located at outer perimeter side of the rotor 2. Magnet pole pieces 3 formed by magnetic materials such as magnetic steel sheet are disposed between the segment magnets 1 disposed along the circumferential direction.

FIG. 2 is a diagram showing a rotor portion of a conventional surface permanent magnet (SPM) motor. In surface permanent magnet motors, the magnet 1 is disposed along the circumferential direction of the rotor 2. Namely, the inner perimeter surface of the stator is located at outer perimeter side of the rotor 2.

The I-type interior permanent magnet rotor shown in FIG. 1 may have a longitudinal size of the magnet 1 larger than that of the conventional surface permanent magnet rotor shown in FIG. 2. I-type interior permanent magnet rotors may generate attractive force equivalent to that of rotors using rare-earth magnets, even when using ferrite magnets having magnetic coercive force one-third as large as that of rare-earth magnets, by enlarging the surface area of magnets three times as large as that of rare-earth magnets. Although the volume of magnets will increase by enlarging the surface area of the magnets, the cost of rotating electrical machine can be reduced because the unit cost per weight is low.

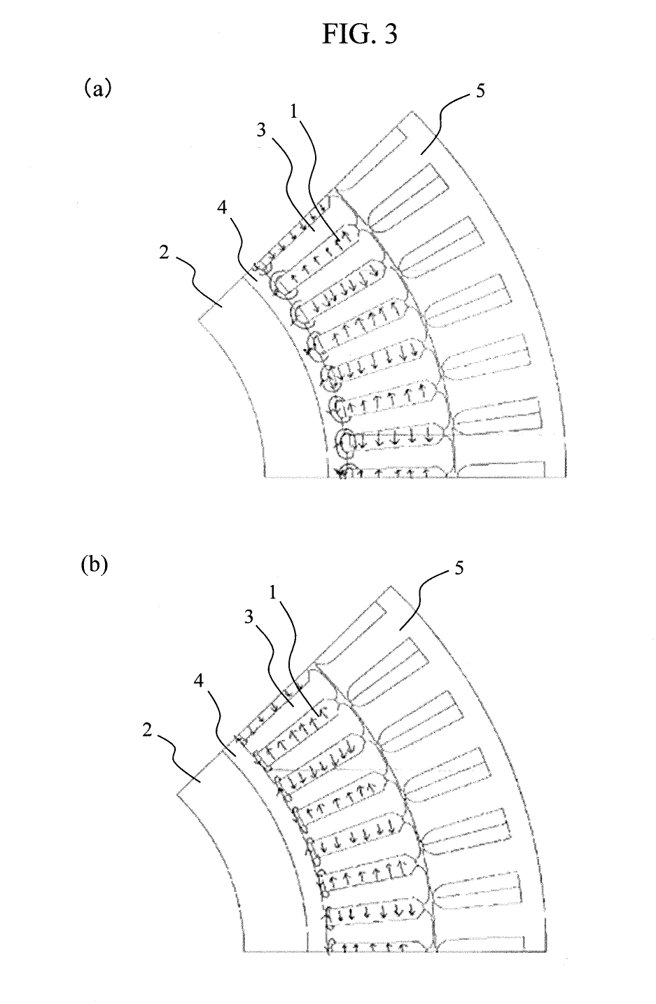

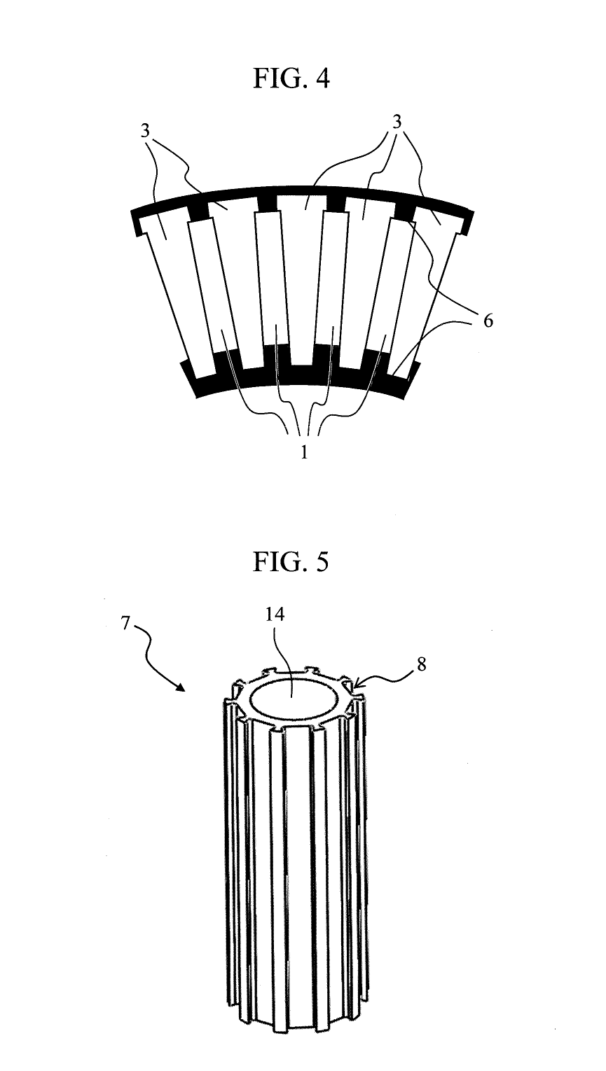

FIG. 3 is a diagram showing a magnetic flux flow of an I-type interior permanent magnet rotor. FIG. 3 (a) shows a magnetic flux flow in which the inner perimeter side 4 of the permanent magnet 1 is made of a magnetic material. FIG. 3 (b) shows a magnetic flux flow in which the inner perimeter side 4 is made of a non-magnetic material.

I-type interior permanent magnet rotors require the magnetic pole pieces 3 to be fixed, without contacting with each other, with the rotor inner perimeter portion 4. If the rotor inner perimeter portion 4 is made of magnetic material, a redundant magnetic flux flows between the rotor inner perimeter portion 4 and the permanent magnet 1 as shown in FIG. 3 (a). This reduces the amount of magnetic flux flowing between the stator 5 and the permanent magnet 1. Therefore, desired torques might not be acquired in some cases. By configuring the rotor inner perimeter portion 4 with non-magnetic material members, it is possible to reduce redundant magnetic fluxes flowing through the rotor inner perimeter portion 4 to effectively use the magnetic flux, thereby improving attractive force.

FIG. 4 is a diagram showing measures for fixing members in an existing I-type interior permanent magnetic rotor. In FIG. 4, the magnetic pole piece 3 and the permanent magnet 1 are disposed alternately along the circumferential direction, the whole body is molded by a resin 6 (non-magnetic material), and the rotating axis is assembled to configure a rotor. PBT (Poly Butylene Terephthalate), PPS (Polyphenylene Sulfide), thermoplastic resins such as LCP (Liquid Crystal Polymer) resin, and thermosetting resins such as BMC (Bulk Molding Compound) are examples of the resin 6.

Redundant magnetic flux flows shown in FIG. 3 (a) can be suppressed by fixing the magnetic pole piece 3 and the permanent magnet 1 using the resin 6. However, such a configuration includes concerns in terms of stiffness or thermal tolerance. Thus the present invention proposes a structure of I-type interior permanent magnet rotor with suppressed redundant magnetic flux flow and increased stiffness.

### Embodiment 1

### Configuration of Rotating Electrical Machine

Hereinafter, each of members configuring a rotating electrical machine according to an embodiment 1 of the present invention and assembling processes thereof will be described using FIG. 5 to FIG. 13. The rotating electrical machine according to the present invention has a structure in which the magnetic pole piece 3 and the permanent magnet 1 are fixed at outer perimeter of an attachment ring 7.

FIG. 5 is a perspective view of the attachment ring 7. The attachment ring 7 as shown in FIG. 5 is manufactured using non-magnetic metals such as aluminum (A5052, A2017, A7075 defined in JIS (Japan Industrial Standard)), or stainless (SUS304, SUS305 defined in JIS).

If the attachment ring 7 is manufactured as a bulk member, manufacturing methods such as cutting, extrusion molding, or casting are used. An engaging portion 8 in which the magnetic pole piece 3 is fitted is provided in the outer perimeter portion of the attachment ring 7. The engaging portion 8 has a groove-like form or a protruded form in accordance with the form of the corresponding engaging portion included in the magnetic pole piece 3. A center hole 14 is for inserting a shaft 15 described later.

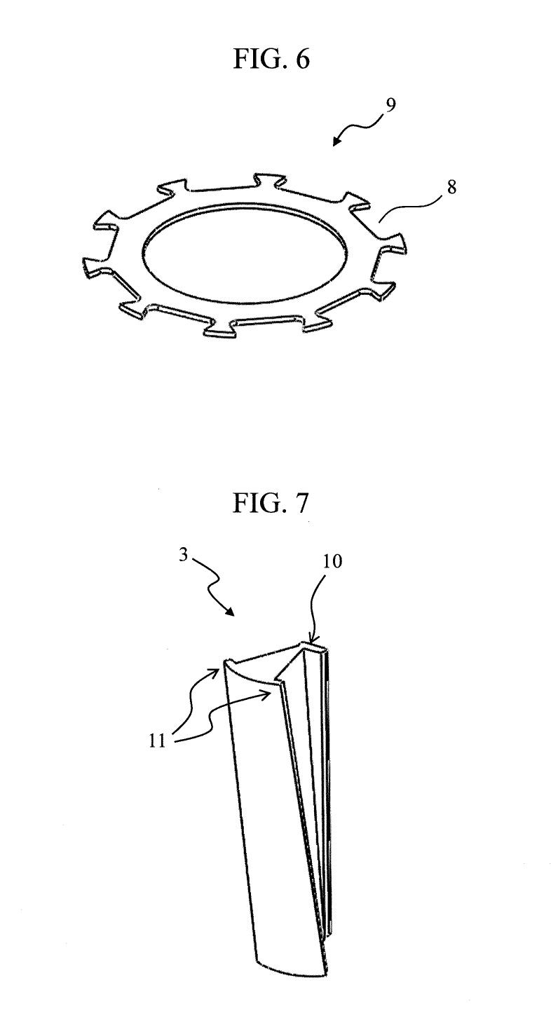

FIG. 6 is a perspective diagram of a plate piece 9 for manufacturing the attachment ring 7. The attachment ring 7 can also be manufactured by stacking the plate piece 9 formed by non-magnetic material as shown in FIG. 6 in the rotating axis direction. The engaging portion 8 is formed at the outer perimeter portion of the plate piece 9 in the same manner as FIG. 5. Each of the plate pieces 9 can be fixed by, for example, swaging or welding.

FIG. 7 is a perspective diagram of the magnetic pole piece 3. The magnetic pole piece 3 has a form with a skew angle with respect to the direction to which the rotating axis is extended. According to this structure, the permanent magnet 1 is attached between the adjacent magnetic pole pieces 3 so that the magnetic flux is skewed with respect to the rotating axis.

An engaging portion (protrusion) 10 for fitting with the engaging portion 8 of the attachment ring 7 is provided at the rotating axis side of the magnetic pole piece 3 (the portion attached to the attachment ring 7). The engaging portion 10 of the magnetic pole piece 3 and the engaging portion 8 of the attachment ring 7 are formed parallel to the direction to which the rotating axis is extended. This configuration enables fitting the magnetic pole piece 3 along the longitudinal direction of the attachment ring 7, thereby making assembling operations easy. As long as not hindering assembling operations, it is not necessary that the engaging portion 10 of the magnetic pole piece 3 and the engaging portion 8 of the attachment ring 7 are parallel to the rotating axis. For example, they may be inclined by some degree to the rotating axis. Namely, the engaging portion 10 of the magnetic pole piece 3 and the engaging portion 8 of the attachment ring 7 should be at least extended in the direction to which the rotating axis is extended.

A bridge 11 is provided at the outer perimeter side of the magnetic pole piece 3 (the opposite side to the portion attached to the attachment ring 7) so that the permanent magnet 1 (or coil) does not protrude to the outer perimeter of the rotor. A groove in which wedges are inserted may be provided instead of the bridge 11.

The magnetic pole piece 3 may be formed by securing powder-like magnetic materials using sintering or bind materials (adhesive agents) or by punching and stacking magnetic steel sheets with insulation coatings and then fixing it (using swaging or welding). The manufacturing method by punching and stacking will be described later.

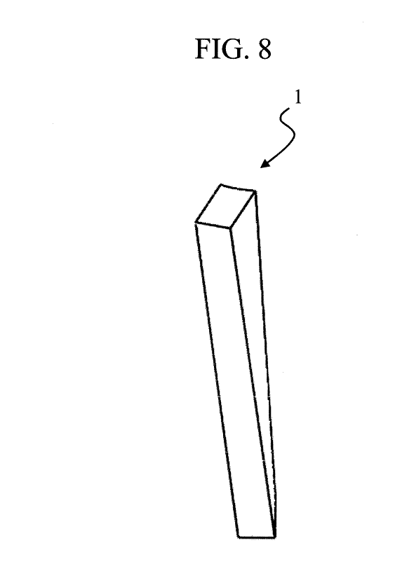

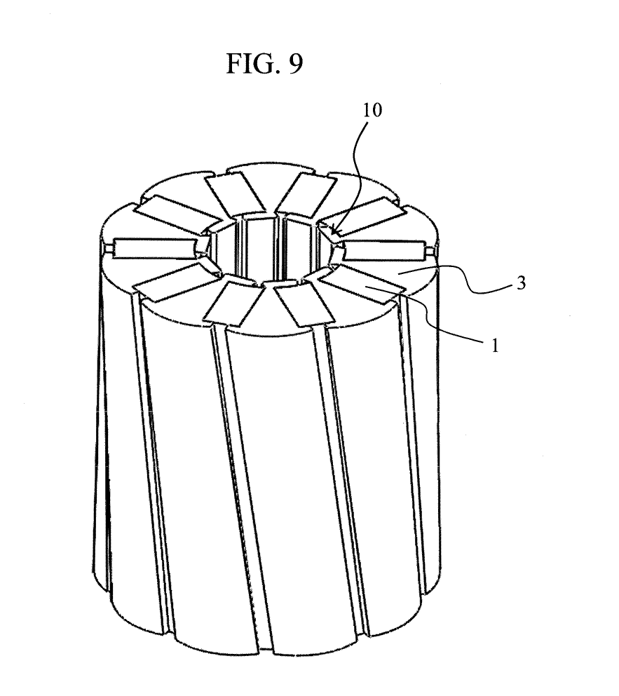

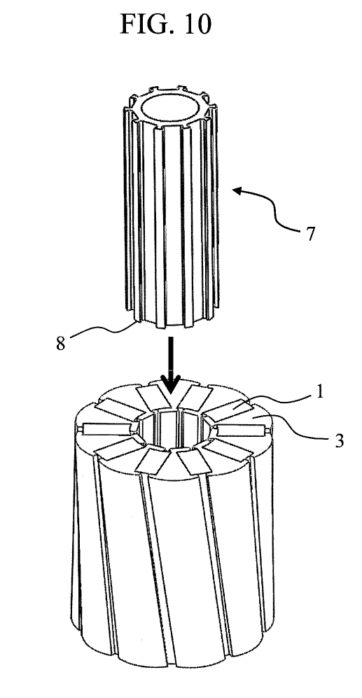

FIG. 8 is a perspective view of the permanent magnet 1. The permanent magnet 1 has a shape so that a skew angle is formed with respect to the rotating axis direction when disposed between the magnetic pole pieces 3. The permanent magnet 1 may be manufactured by machining sintered magnets or by using bond magnets molded after mixing magnet powders into resin.

FIG. 9 is a perspective view showing that the magnetic pole piece 3 and the permanent magnet 1 are annularly disposed. It can be understood that the permanent magnet 1 is skewed with respect to the rotating axis direction in accordance with the skewed shape of the magnetic pole piece 3. Note that the magnetic pole piece 3 is not attached to the attachment ring 7 in FIG. 9.

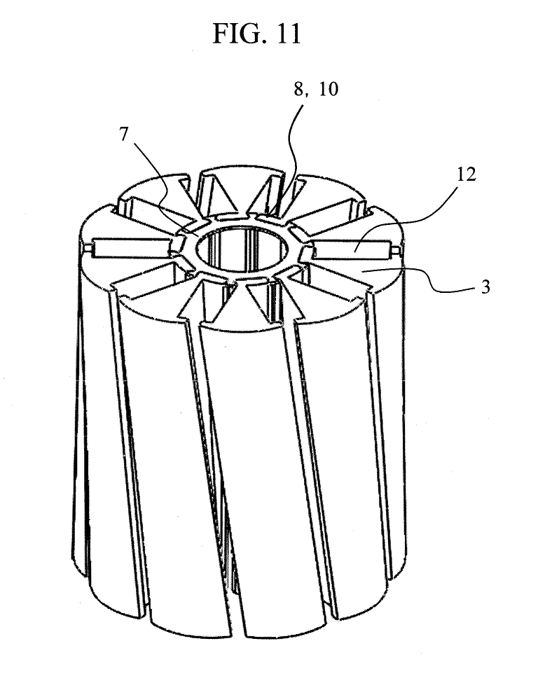

FIG. 10 is a diagram showing a process to fit the attachment ring 7 into the magnetic pole piece 3. Under the state shown in FIG. 9, the engaging portion 10 of the magnetic pole piece 3 and the engaging portion 8 of the attachment ring 7 are aligned to each other and then fitted along the rotating axis. Since the engaging portion 10 of the magnetic pole piece 3 and the engaging portion of the attachment ring 7 are both parallel (or approximately parallel) to the rotating axis, this process can be easily performed. Furthermore, in order to prevent damage to the permanent magnet 1, the magnet pole piece 3, the permanent magnet 1, and the attachment ring 7 may be secured using adhesive agents.

FIG. 11 is a diagram explaining another method for assembling the magnetic pole piece 3, the permanent magnet 1, and the attachment ring 7. First, only the magnetic pole piece 3 is disposed cylindrically in the same manner as FIG. 9. Then the engaging portion 10 of the magnetic pole piece 3 and the engaging portion 8 of the attachment ring 7 are aligned to each other and then fitted in the same manner as FIG. 10. Next, these members are set in a mold, and bond magnets are injected into a groove 12 formed by the magnetic pole piece 3 and the attachment ring 7.

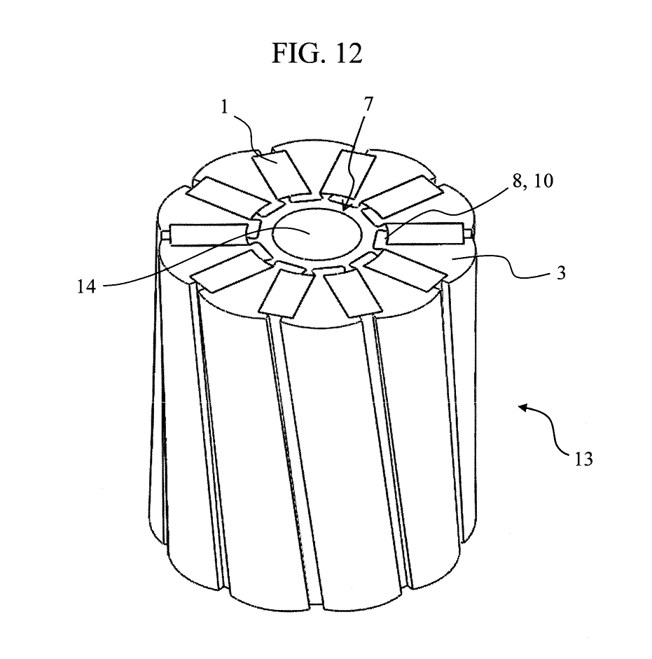

FIG. 12 is a perspective view of an assembly 13. According to the above-described processes, the assembly 13 in which the magnetic pole piece 3 with skew angle is stiffly fixed to the attachment ring 7 is formed. As long as necessary, a ring-like fastening member (not shown) is attached to the edge surface in the axial direction of the components so that the permanent magnet 1, the magnetic pole piece 3, and the attachment ring 7 will not be separated. The shaft 15 (not shown) is inserted into the hole 14 of the attachment ring 7. Knurling (sticking a protrusion formed in the surface of the shaft 15 into the inner perimeter of the hole 14), press fitting, key fixing (note that key grooves of the hole 14 are not shown in FIG. 12), or the like can be used to integrate these members. According to the above-described processes, the I-type interior permanent magnet rotor is formed.

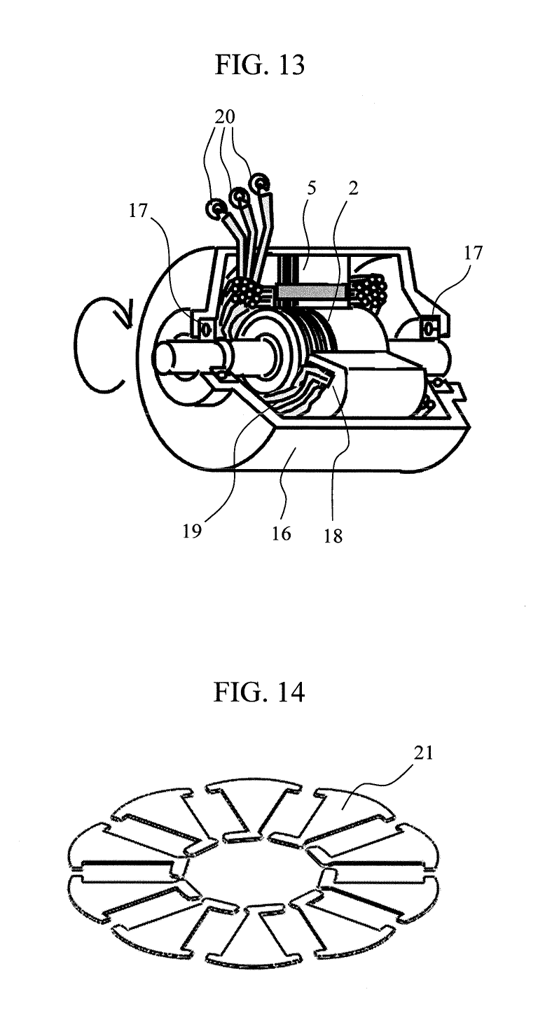

FIG. 13 is an inner perspective view of a rotating electrical machine equipping with the I-type interior permanent magnet rotor 2 according to the embodiment 1. The I-type interior permanent magnet rotor 2 is embedded into the inner perimeter of the stator 16. Both sides of the I-type interior permanent magnet rotor 2 are rotatably supported by bearings 17. The stator 16 is formed by: punching into cylindrical shape a magnetic steel sheet having a plurality of grooves (slots) 18 at inner perimeter; stacking and fixing it; protecting around teeth by insulators made of resin; winding a coil 19; and connecting terminal wires of the coil 19 to configure an electric circuit. When inputting an electric current to flow through an input wire 20 of the coil 19, a rotating magnetic field is generated in the inner perimeter surface of a stator core 5 by the coil 19. The rotating magnetic field and the permanent magnet 1 (not shown) of the I-type interior permanent magnet rotor 2 are attracted to each other to synchronously rotate.

So far, the configuration of the rotating electrical machine according to the embodiment 1 has been described. Hereinafter, a process for manufacturing the magnetic pole piece 3 with skew angle will be described.

### Embodiment 1

### Process for Manufacturing the Magnetic Pole Piece 3

FIG. 14 is a perspective view of a punched member 21 forming the magnetic pole piece 3. The punched member 21 can be formed using, for example, an oriented magnetic steel sheet with thickness of 0.35 mm or 0.5 mm. The magnetic pole piece 3 is formed by stacking the punched member 21. In order to align the inner perimeter side of the magnetic pole piece 3 (the portion attached to the attachment ring 7) parallel to the rotating axis and in order to provide a skew angle only at the outer perimeter side, the following process is employed.

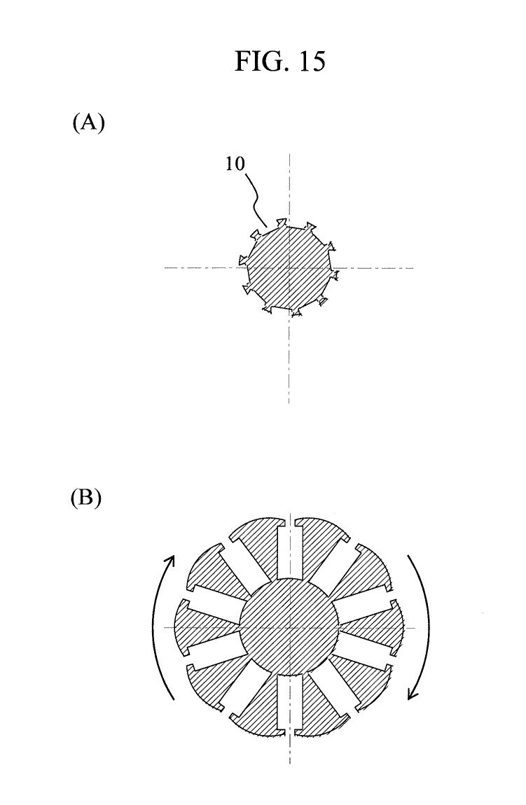

FIG. 15 is a top view of two types of punches used for punching the punched member 21. The punched member 21 can be formed by punching a magnetic steel sheet or the like using these punches in sequential molding. FIG. 15 (A) is a punch for forming the inner perimeter portion of the punched member 21. FIG. 15 (B) is a punch for forming the protruded shape of the punched member 21.

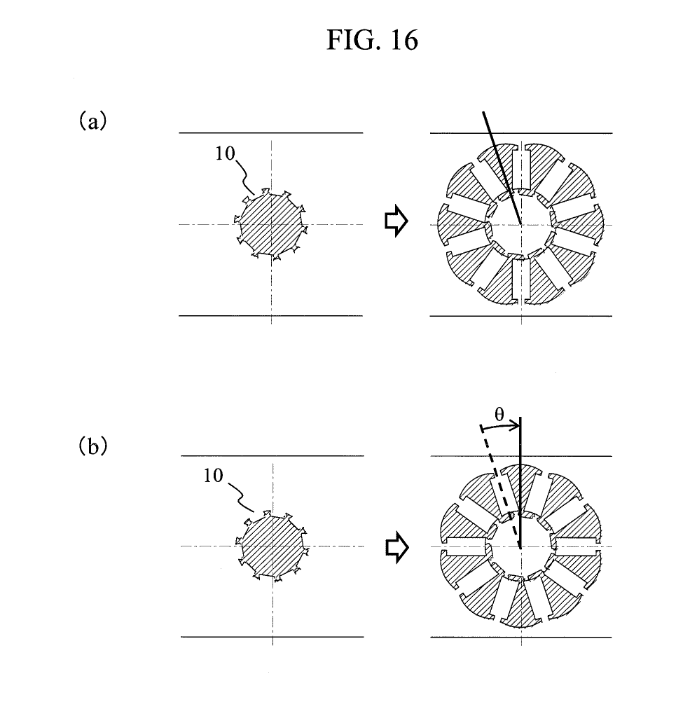

FIG. 16 is a diagram explaining a difference about positions where the steel sheet is punched. In order to form the skew angle of the magnetic pole piece 3, the punch of FIG. 15 (B) is rotated for each time punching one sheet of the steel. As a result, the outer perimeter portion of the punched member 21 is shifted along the circumferential direction by a certain angle for each of layers of the steel sheet. Thus after stacking the punched member 21, a skew angle is formed at the outer perimeter portion of the magnetic pole piece 3. In addition, the punch of FIG. 15 (A) is used at the same position for all layers. As a result, the inner perimeter portion of the punched member 21 is located at the same position for all layers. Thus the inner perimeter portion of the magnetic pole piece 3 is aligned parallel to the rotating axis.

If the engaging portion 10 of the magnetic pole piece 3 is aligned approximately parallel to the rotating axis direction, formable skew angle may be limited depending on the size and shape of the magnetic pole piece 3. For example, regarding the I-type interior permanent magnet rotor 2 according to the embodiment 1, the skew angle is limited to below ½ of the angle between adjacent magnetic pole pieces 3. This is because if the skew angle is above that limit, it exceeds the size of the engaging portion 10.

### Embodiment 1

### Conclusion

As described above, the rotating electrical machine according to the embodiment 1 may provide, by forming a skew angle in the magnetic pole piece 3 and in the permanent magnet 1, an I-type interior permanent magnet rotor 2 with small cogging torque. In addition, by configuring the engaging portion 10 of the magnetic pole piece 3 and the engaging portion 8 of the attachment ring 7 parallel to the rotating axis, the process for fitting these members is made easy, thereby improving stiffness.

### Embodiment 2

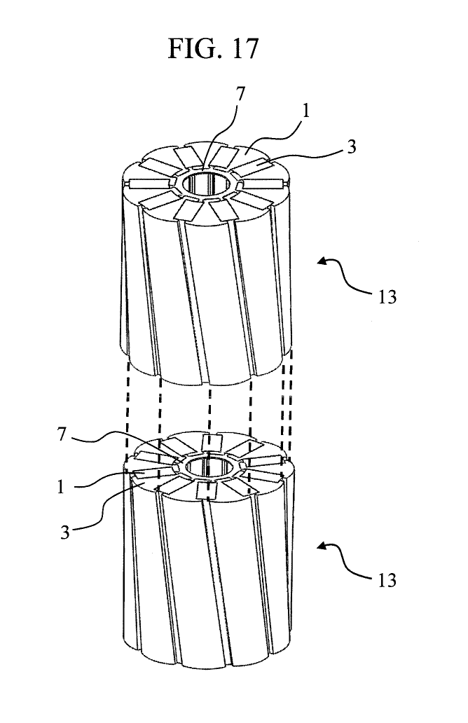

FIG. 17 is a perspective view showing a process for stacking a plurality of the assembly 13. As described in the embodiment 1, the skew angle of the magnetic pole piece 3 is below ½ of the angle between adjacent magnetic pole pieces 3. If a larger skew angle is required, a plurality of the assembly 13 may be stacked in the rotating axis direction and each of the assembly 13 may be disposed so that the skew portion of the magnetic pole piece 3 becomes continuous between each of the assemblies 13.

### Embodiment 3

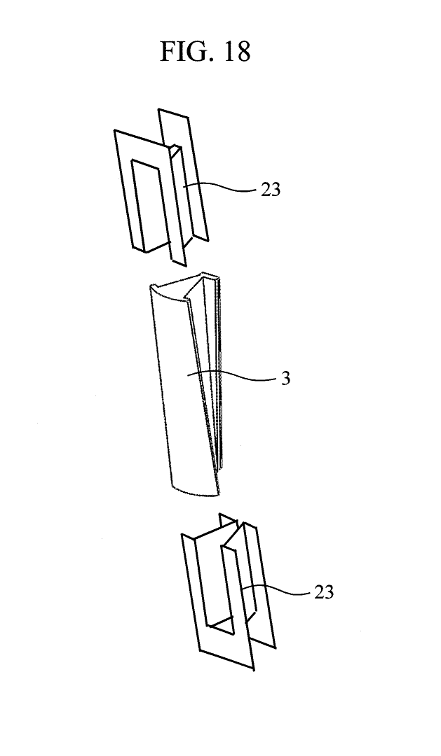

FIG. 18 is a diagram showing a configuration example when using a coil instead of the permanent magnet 1. In this case, a bobbin 23 made of resin is attached from top and bottom of the magnetic pole piece 3, the bobbin 23 is winded (not shown), and the wired bobbin 23 is assembled with the attachment ring 7. As a result, a concentrated winding rotor for DC brushless motor with skew angle can be configured. Windings can be provided with high density by dividing the magnet pole piece 3 from the attachment ring 7. In addition, torque pulsation can be decreased by providing a skew angle in the magnetic pole piece 3.

The present invention is not limited to the aforementioned embodiments, and various modifications are possible. The above-described embodiments are directed to detailed explanation for clear understanding of the present invention, and the present invention is not limited to the configuration having all described components. In addition, a part of a configuration of an embodiment may be replaced with a configuration in another embodiment. Further, a configuration is an embodiment may be added to a configuration in another embodiment. Yet further, a part of a configuration in an embodiment may be appended, deleted, or replaced by another configuration.

### DESCRIPTION OF SYMBOLS

1: Permanent magnet, 2: Rotor, 3: Magnetic pole piece, 4: Rotor inner perimeter, 5: Stator, 6: Resin, 7: Attachment ring, 8: Engaging portion, 9: Plate piece, 10: Engaging portion, 11: Bridge, 12: Groove, 13: Assembly, 14: Hole, 15: Shaft, 16: Stator, 17: Bearing, 18: Slot, 19: Coil, 20: Input wire, 21: Punched member, 23: Bobbin

What is claimed is:

1. A rotating electrical machine comprising:
a plurality of magnetic pole pieces that is disposed with a skew angle with respect to a direction to which a rotating axis is extended; and
a cylindrical attachment ring to which the plurality of magnetic pole pieces is attached;
wherein
an engaging portion provided at an outer perimeter of the attachment ring and an engaging portion included in the magnetic pole piece are fitted with each other to fix the magnetic pole piece and the attachment ring;
a permanent magnet or a coil is disposed at a gap portion between the adjacent magnetic pole pieces; and
the engaging portion provided at the outer perimeter of the attachment ring and the engaging portion included in the magnetic pole piece are both extended along the rotating axis.

2. The rotating electrical machine according to claim 1, wherein
the engaging portion provided at the outer perimeter of the attachment ring and the engaging portion included in the magnetic pole piece are both extended in parallel to the direction to which the rotating axis is extended.

3. The rotating electrical machine according to claim 1, wherein
the magnetic pole piece is formed using a magnetic material; and
the attachment ring is formed using a non-magnetic material.

4. The rotating electrical machine according to claim 3, wherein
the magnetic pole piece is formed by stacking a magnetic plate member that is formed using a magnetic material.

5. The rotating electrical machine according to claim 1, wherein
a plurality of assembly in which the magnetic pole piece is attached to the outer perimeter of the attachment ring is stacked along the rotating axis; and
each of the assembly is disposed so that the skew of the magnetic pole piece included in each of the assembly becomes continuously connected between each of the assembly.

6. The rotating electrical machine according to claim 1, wherein
the attachment ring is formed using a non-magnetic metal.

7. The rotating electrical machine according to claim 6, wherein
the attachment ring is formed using at least one of A5052, A2017, A7075, SUS304, and SUS 305 that are defined in JIS as non-magnetic metals.

8. A method for manufacturing a magnetic pole piece that is radially attached to an outer perimeter of a rotating axis included in a rotating electrical machine, comprising:
a first step of punching a center portion of a magnetic plate member that is formed using a magnetic material to form an engaging portion that is provided at an edge portion of the magnetic pole piece closer to the rotating axis than another edge portion;
a second step of punching the magnetic plate member to form a protruded shape that is provided at an edge portion of the magnetic pole piece farer from the rotating axis than another edge portion; and
a third step of stacking a plurality of the plate member in which the engaging portion and the protruded shape are formed;
wherein
in the first step, the plate member is punched at a constant position for each of the plate member; and
in the second step, the plate member is punched at a position shifted by a constant rotation angle along a rotation direction of the rotating axis for each of the plate member.
